(19) United States
(12) Patent Application Publication
(10) Pub. No.: US 2009/0167175 A1
(43) Pub. Date: Jul. 2, 2009

(54) PLASMA DISPLAY PANEL

(76) Inventor: Taiki Makino, Kunitomi (JP)

Correspondence Address: MCDERMOTT WILL & EMERY LLP, 600 13TH STREET, N.W., WASHINGTON, DC, 20005-3096, US

(21) Appl. No.: 12/239,033

(22) Filed: Sep. 26, 2008

(30) Foreign Application Priority Data
Dec. 28, 2007 (JP) 2007-340426

(51) Int. Cl. H01J 17/49

(52) U.S. Cl. 313/582

(57) ABSTRACT

A plasma display panel includes a pair of opposing substrates, a plurality of display electrodes which form display lines on a screen, and a plurality of address electrodes which intersect with the display electrodes. Each of the display electrodes has a bus electrode extending in a row direction, and a plurality of branch electrodes each protruding from the bus electrode to another adjacent display electrode. Each of the branch electrodes has a head portion disposed in parallel with the bus electrode to form a discharge gap and a neck portion connecting the bus electrode and the head portion to each other. At least one of the neck portion and the address electrode is disposed so as to diagonally cross each cell so that an overlapped area between the neck portion and the address electrode is always formed as a certain area, whereby the neck portion and the address electrode are disposed so as to diagonally intersect with each other in a plane view of the panel.

### CROSS-REFERENCE TO RELATED APPLICATION

This application is related to Japanese application No. 2007-340426, filed on Dec. 28, 2007, whose priority is claimed under 35 USC §119, the disclosure of which is incorporated by reference in its entirety.

### BACKGROUND OF THE INVENTION

1. Field of the Invention

The present invention relates to a plasma display panel (hereinafter, referred to as a “PDP”), and more specifically, to a three-electrode surface discharge type PDP of AC-drive-type.

2. Description of the Related Art

The three-electrode surface discharge type PDP of AC-drive-type is produced through processes in which a large number of display electrodes capable of producing a surface discharge are disposed on the inner face of a substrate on the front face side in a predetermined direction (normally, in a row direction of the display screen), with a large number of address electrodes used for selecting light-emitting cells being disposed on the inner face of a substrate on the back face side in a direction that intersects with the display electrodes, and in a state where the substrate on the front face side and the substrate on the back face side are made face to face with each other, with a discharge space interposed therebetween, the peripheral portion is sealed, with a discharge gas being sealed inside thereof. In this case, an intersecting portion between the paired display electrodes and the address electrode forms one cell (unit light-emitting area). One pixel is configured by three cells, that is, a red (R) cell, a green (G) cell and a blue (B) cell.

In general, the display electrodes are made of transparent electrodes such as ITO and bus electrodes made of metal, and known examples thereof include T-letter-shaped electrodes shown in FIG. 7 and so-called ladder-shaped electrodes shown in FIG. 8. FIGS. 7 and 8 show a state of one cell viewed on the plan view. These T-letter-shaped electrodes and ladder-shaped electrodes have a structure in which each of branch electrodes (transparent electrodes) 52 protrudes from a band-shaped bus electrode 51 forming a base portion of the display electrodes toward another adjacent display electrode. Each branch electrode 52 is configured by a head portion 52a forming a discharge slit D used for surface-discharging and a neck portion 52b that connects the bus electrode 51 and the head portion 52a to each other. An address electrode A is extended linearly in the center of the cell. This three-electrode surface discharge type PDP having these three electrodes has been disclosed in Japanese Unexamined Patent Publication No. HEI 8(1996)-22772 or the like.

Upon driving this three-electrode surface discharge type PDP, a counter discharge (referred to as an address discharge) is generated between the display electrodes 51, 52 and the address electrode A so as to select a cell to be displayed, and thereafter, a surface discharge is generated in the discharge gap (discharge slit) D between the head portion 52a of one of the display electrodes and the head portion 52a of the other display electrode.

In the PDP having the above-mentioned T-letter-shaped electrodes and ladder-shaped electrodes, however, the neck portion 52b of the display electrode is positioned so as to face the address electrode A in parallel therewith, when the panel is viewed on the plan view. Consequently, due to influences upon production, such as an overlapping deviation between the substrate on the front face side and the substrate on the back face side, a formation deviation of the electrodes and partially different rates of shrinkage of the substrates, the area on which electrodes to generate an addressing counter discharge are superposed on each other becomes uneven within the display surface, with the result that irregularities tend to occur in the discharge starting voltage upon generating the counter discharge in each cell. In particular, in the PDP that provides high precision display, discharge irregularities of the counter discharge occur more easily, making it difficult to maintain the operating margin to easily cause a problem of degradation of display quality.

### SUMMARY OF THE INVENTION

The object of the present invention is to provide a PDP that causes no discharge irregularities upon generating an addressing counter discharge.

In order to achieve the above object, the present invention has proposed an electrode layout in which electrodes to generate a counter discharge are allowed to intersect with each other so that, even if a positional deviation occurs between the electrodes to generate a counter discharge, the opposing area of the electrodes is kept unchanged.

More specifically, the present invention provides a plasma display panel comprising: a pair of opposing substrates forming a discharge space therebetween; a plurality of display electrodes placed on an inner face of one of the substrates to form display lines on a screen; and a plurality of address electrodes placed on an inner face of the other substrate to intersect with the display electrodes and define a cell at an intersecting portion of each display electrode and each address electrode, wherein each of the display electrodes has a band-shaped bus electrode extending over the total length of the screen in a row direction, and a plurality of branch electrodes each protruding from the bus electrode to another adjacent display electrode, each of the branch electrodes has a head portion disposed in parallel with the bus electrode to form a discharge gap and a neck portion connecting the bus electrode and the head portion to each other, and at least one of the neck portion and the address electrode is disposed so as to diagonally cross each cell so that an overlapped area between the neck portion and the address electrode is always formed as a certain area, whereby the neck portion and the address electrode are disposed so as to diagonally intersect with each other in a plane view of the panel.

In accordance with the present invention, it becomes possible to improve display defectiveness caused by a positional deviation between the display electrodes and the address electrode and also to maintain an operating margin.

### BRIEF DESCRIPTION OF THE DRAWINGS

FIGS. 1(a) and 1(b) are explanatory drawings that show a structure of a first example of a PDP of the present invention;

FIGS. 2(a) and 2(b) are explanatory drawings that show a detailed view of the first example and its modified example of the present invention;

FIGS. 3(a) and 3(b) are explanatory drawings that show a second example and its modified example of the present invention;

FIGS. 4(a) and 4(b) are explanatory drawings that show a third example and its modified example of the present invention;

FIG. 5 is an explanatory drawing that shows an example of a state in which a positional deviation occurs in electrodes of the first example;

FIG. 6 is an explanatory drawing that shows an example of a state in which a positional deviation occurs in electrodes of the second example;

FIG. 7 is an explanatory drawing that shows an example of conventional T-letter-shaped electrodes; and

FIG. 8 is an explanatory drawing that shows an example of a conventional ladder electrode.

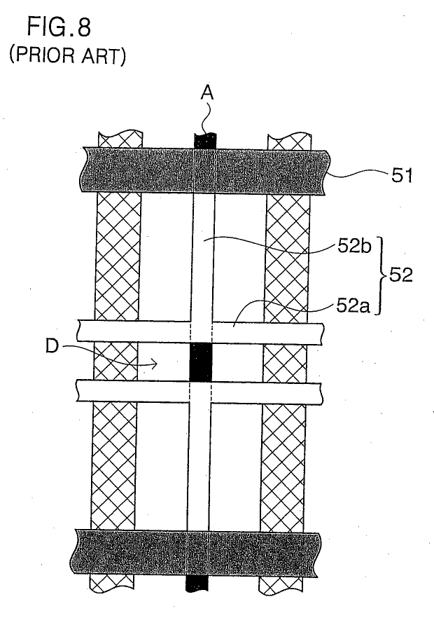

### DESCRIPTION OF THE PREFERRED EMBODIMENTS

In the present invention, examples of paired substrates to be aligned face to face with each other include substrates made of glass, quartz, ceramics and the like and substrates made by forming desired components, such as electrodes, an insulating film, a dielectric layer and a protective film, on these substrates.

A plurality of display electrodes that generate a surface discharge may be prepared as display electrodes disposed on one of the substrates in parallel with a row direction, and a plurality of address electrodes that generate an address discharge may be prepared as address electrodes disposed on the other substrate in parallel with a column direction intersecting with the display electrodes. These electrodes may be formed by using various materials and methods known in the corresponding field. Examples of the material used for the electrodes include transparent conductive materials such as ITO and SnO2, and metal conductive materials such as Ag, Au, Al, Cu and Cr. With respect to the forming method of the electrodes, various methods known in the corresponding field may be used. For example, a thick film forming technique such as printing may be used, or a thin film forming technique including a physical deposition method or a chemical deposition method may be used. The thick film forming technique includes, for example, a screen printing method. The physical deposition method in the thin film forming technique includes, for example, a vapor deposition method and a sputtering method. The chemical deposition method includes, for example, a thermal CVD method, a photo CVD method, or a plasma CVD method.

In the present invention, each display electrode is constituted by a band-shaped bus electrode that extends over the total length of the screen in the row direction and branch electrodes for respective cells, which protrude toward another adjacent display electrode from the bus electrode, and each of the branch electrodes is constituted by a head portion that is placed in parallel with the bus electrode to form a discharge gap and a neck portion that connects the bus electrode and the head portion to each other. Further, when the panel is viewed on the plan view, at least one of the neck portion and the address electrode is placed so as to diagonally cross each cell so that the overlapped area between the neck portion and the address electrode is always allowed to have a predetermined area; thus, the neck portion and the address electrode are placed so as to intersect with each other.

In the present invention, the address electrode may be extended linearly so as to be orthogonal to the bus electrode so that the neck portion is allowed to diagonally intersect with the address electrode. Moreover, the neck portion may be placed so as to be orthogonal to the bus electrode so that the address electrode is allowed to diagonally intersect with the neck portion. Furthermore, the neck portion may be diagonally disposed so that the address electrode is allowed to diagonally cross the neck portion.

The following description will discuss the present invention in detail based upon examples shown in Figures. Here, the present invention is not intended to be limited b y these, and various modifications may be made therein.

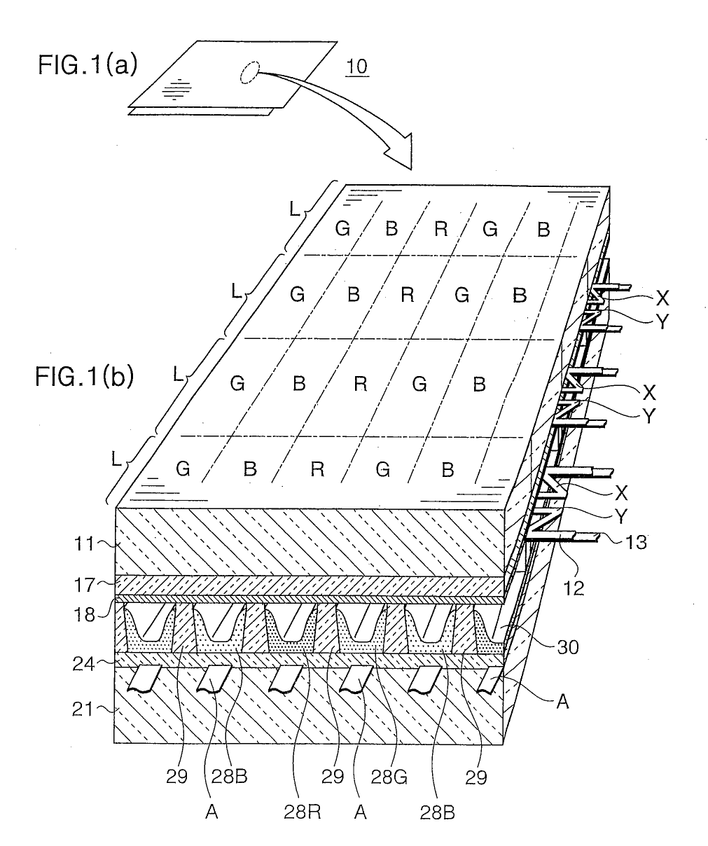

FIGS. 1(a) and 1(b) are explanatory drawings that show a structure of a first example of a PDP of the present invention. FIG. 1(a) is a general view of the PDP, and FIG. 1(b) is a partial exploded perspective view of the PDP. This PDP is a three-electrode surface-discharge-type PDP of AC-drive-type used for color display.

The PDP 10 is constituted by a substrate 11 on the front face side where constituent elements functioning as the PDP are formed and a substrate 21 on the back face side. A substrate, such as a glass substrate, a quartz substrate and a ceramic substrate, may be used as the substrate 11 on the front face side and the substrate 21 on the back face side.

On the inner side face of the substrate 11 on the front face side, paired display electrodes X and Y are disposed with a gap (non-discharge gap) having no discharge generated therein interposed therebetween. A display line L, which defines a row of the screen between the paired display electrodes X and Y, is formed. The display electrode Y, which also functions as a scanning electrode, generates an address discharge between it and an address electrode that will be explained later. Each of the display electrodes X and Y is constituted by branch electrodes 12 made of a transparent conductive material such as ITO and a bus electrode 13 made of metal having a three-layer structure of Cr—Cu—Cr. A desired number of these display electrodes X and Y can be formed, with a desired thickness, width and gap, by using a thin film forming technique, such as a vapor deposition method and a sputtering method, and an etching technique.

Here, in the present PDP, a PDP having a structure in which the paired electrodes X and Y are disposed with a gap (non-discharge gap) having no discharge generated therein interposed therebetween is shown; however, the present invention may also be applied to a PDP having a so-called ALIS structure in which the display electrodes X and the display electrodes Y are disposed with equal intervals, with all the gaps between the adjacent display electrodes X and display electrodes Y forming display lines L.

A dielectric layer 17 is formed on the display electrodes X and Y so as to cover the display electrodes X and Y. The dielectric layer 17 is formed by applying a glass paste made from a glass frit, a binder resin and a solvent to the substrate 11 on the front face side by using a screen printing method, so as to be fired thereon.

On the dielectric layer 17, a protective film 18, used for protecting the dielectric layer 17 from damages caused by collision with ions to be generated by discharge upon displaying, is formed. This protective film is made from MgO. The protective film can be formed by using a thin-film forming process known in the corresponding field, such as an electron beam vapor deposition method and a sputtering method.

On the inner face of the substrate 21 on the back face side, a plurality of address electrodes A are formed in a direction intersecting with the display electrodes X and Y viewed on the plan view, and a dielectric layer 24 is formed in a manner so as to cover the address electrodes A. The address electrodes A, which generate an address discharge used for selecting cells to emit light at intersecting portions with the display electrodes (Y electrodes) that also function as the scanning electrodes, are formed into a three-layer structure of Cr—Cu—Cr. In the same manner as in the display electrodes X and Y, a desired number of these address electrodes A can also be formed, with a desired thickness, width and gap, by using a thin film forming technique, such as a vapor deposition method and a sputtering method, and an etching technique. The dielectric layer 24 can be formed by using the same material and the same method as those of the dielectric layer 17.

A plurality of barrier ribs 29, each having a stripe shape, are formed on the address electrode A and the dielectric layer 24 located between the address electrodes A adjacent to each other. Not limited to this, the shape of the barrier ribs 29 may be prepared as closed-type barrier ribs that divide the discharge space for each cell (barrier ribs, referred to as lattice-type, mesh-type and box-type barrier ribs). The barrier ribs 29 can be formed by using a sand-blasting method, a printing method or a photo-etching method or the like. For example, in the sand-blasting method, after applying a glass paste made from a low-melting-point glass frit, a binder resin, a solvent or the like onto the dielectric layer 24 to be dried thereon, cutting grains are blown onto the glass paste layer, with a cutting mask having openings for the barrier rib pattern placed thereon, so that the glass paste layer exposed to the openings of the mask is cut off, and this is then fired so that the barrier ribs are formed. Moreover, in the photo-etching method, in place of the cutting process using the cutting grains, a photosensitive resin is used as the binder resin, and after exposing and developing processes by using a mask, the firing process is carried out thereon so that the barrier ribs are formed.

On the side faces and the bottom face of a discharge space having a groove shape between the barrier ribs 29, phosphor layers 28R, 28G and 28B of red (R), green (G) and blue (B) are formed. Each of the phosphor layers 28R, 28G and 28B is formed through processes in which a phosphor paste containing phosphor powder, a binder resin and a solvent is applied to the inside of the groove-shaped discharge space between the barrier ribs 29 by using a screen printing process, a method using a dispenser, or the like, and after this process has been repeated for each of the colors, a firing process is carried out thereon. These phosphor layers 28R, 28G and 28B may also be formed through a photolithographic technique by using a sheet-shaped phosphor layer material (so-called green sheet) containing phosphor powder, a photosensitive material and a binder resin. In this case, a sheet having a desired color is affixed onto the entire face of a display area on the substrate, and the sheet is subjected to exposing and developing processes; thus, by repeating these processes for each of the colors, phosphor layers having the respective colors are formed between the corresponding barrier ribs.

The PDP is manufactured through processes in which the substrate 11 on the front face side bearing these constituent elements formed thereon and the substrate 21 on the back face side are aligned face to face with each other in a manner so as to allow the display electrodes X, Y and address electrodes A to intersect with each other, and the peripheral portion thereof is then sealed, with a discharge space 30 surrounded by the barrier ribs 29 being filled with a discharge gas formed by mixing Xe, Ne or the like. In this PDP, the discharge space 30 in each of the intersecting portions between the display electrodes X, Y and the address electrodes A forms one cell (unit light-emitting area), that is, the minimum unit for display. One pixel is configured by three cells of R, G and B.

The following description will discuss examples of the electrode shape of the PDP characterized by the present invention.

### First Example

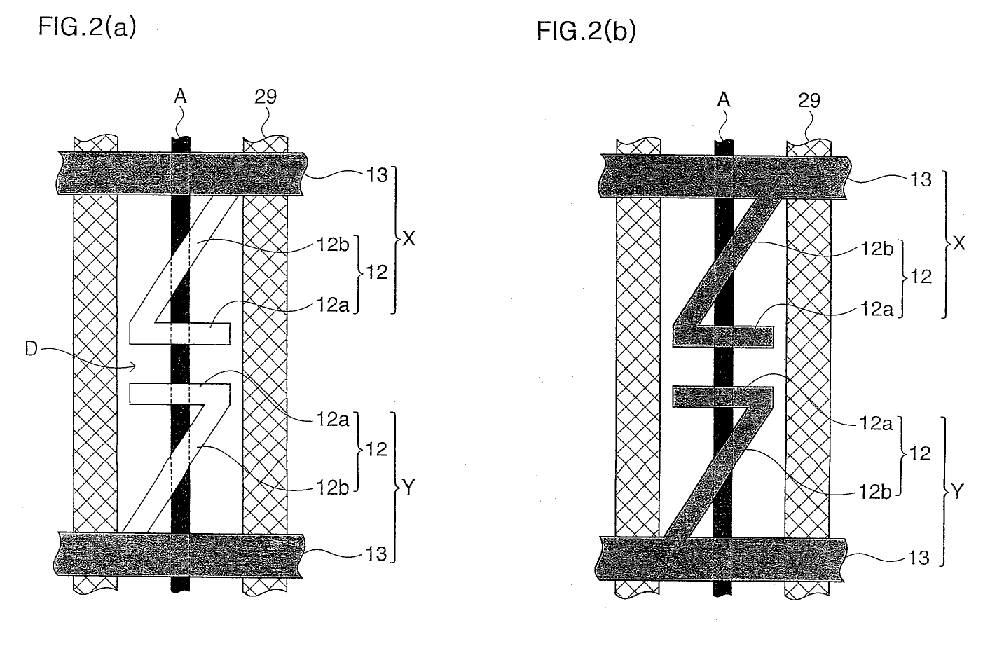

FIG. 2(a), which is an explanatory drawing showing a detailed view of the first example, shows a state in which one of cells of the PDP is viewed on the plan view.

Each of display electrodes X and Y is constituted by a band-shaped bus electrode 13 that extends over the total length of a screen in the row direction and branch electrodes 12 that protrude toward another adjacent display electrode from the bus electrode 13. Each of the branch electrodes 12 is constituted by a head portion 12a that is placed in parallel with the bus electrode 13 to form a discharge slit (discharge gap) D and a neck portion 12b that connects the bus electrode 13 and the head portion 12a to each other.

When the panel is viewed on the plan view, an address electrode A is extended linearly in parallel with (in a column direction) the barrier ribs 29. Further, the neck portion 12b is placed so as to diagonally cross each cell so that the overlapped area between the neck portion 12b and the address electrode A is always allowed to have a predetermined area; thus, the neck portion 12b and the address electrode A are placed so as to diagonally intersect with each other.

In this manner, the head portion 12a is disposed in parallel with the bus electrode 13. Moreover, the neck portion 12b that connects the head portion 12a and the bus electrode 13 to each other is diagonally placed. The address electrode A is a linear electrode without a pad portion, and is disposed in the center of the cell so as to be orthogonal to the bus electrode 13 and the head portion 12a.

By forming the electrodes into these shapes, the shape of a portion where electrodes to generate an addressing counter discharge are allowed to intersect with each other, that is, the shape of a portion where the neck portion 12b and the address electrode A are allowed to intersect with each other, is formed into a parallelogram, when the panel is viewed on the plan view. For this reason, even when the intersecting portion of the neck portion 12b and the address electrode A deviates in either of the horizontal direction and the vertical direction, due to an influence upon production, such as an overlapping deviation between the substrate on the front face side and the substrate on the back face side, a formation deviation between the electrodes, and a partial difference in rates of shrinkage occurred in the substrate, the intersecting area between the neck portion 12b and the address electrode A is kept unchanged.

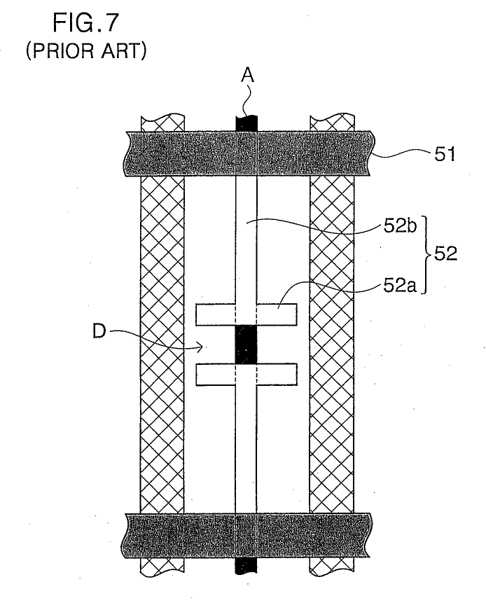

With this arrangement, since the area where the electrodes to generate an addressing counter discharge are mutually superposed is evenly maintained at all the cells forming the display face, no irregularities occur in the discharge starting voltage of the counter discharge, and it becomes possible to easily maintain an operating margin. Since the shape of the head portion 12a is the same as that of the T-letter-shaped electrode shown in FIG. 7, the characteristics of the surface discharge are substantially the same as those of the T-letter-shaped electrode.

In each of the head portion 12a and the bus electrode 13, if there is a sufficient room for deviations, a pad portion may be formed on the address electrode A so as to be superposed on the corresponding area. A plurality of portions at which the neck portion 12b and the address electrode A are allowed to intersect with each other may be formed.

FIG. 2(b) is an explanatory drawing that shows a modified example of the first example. In this modified example, the branch electrodes 12 are made of the same metal material as that of the bus electrode 13. The other structures are the same as those of the first example.

### Second Example

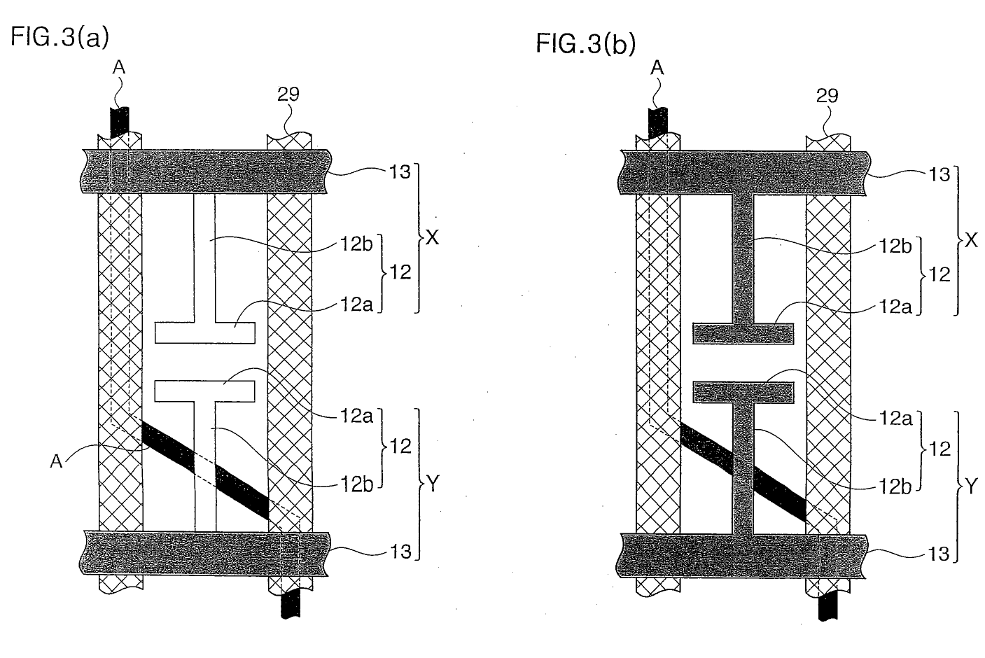

FIG. 3(a) is an explanatory drawing that shows a second example. In this example, when the panel is viewed on the plan view, the head portion 12a is disposed in parallel with the bus electrode 13. Moreover, the neck portion 12b is disposed in parallel with the barrier ribs 29, and each of the branch electrodes of the display electrodes X and Y is formed into a so-called T-letter-shaped electrode. The address electrode A is disposed so as to diagonally cross each cell, and the neck portion 12b of the display electrode and the address electrode A are disposed so as to diagonally intersect with each other. With this arrangement, even if there is a positional deviation occurring in the electrodes, the area at which the neck portion 12b and the address electrode A are superposed on each other is always allowed to have a predetermined area.

As described above, instead of diagonally disposing the neck portion 12b of the display electrodes X and Y as shown in the first example, the address electrode A may be diagonally disposed. However, in order to prevent influences from the head portion 12a of the display electrodes X and Y due to a positional deviation between the electrodes, the head portion 12a may be narrowed, or the linear portion of the address electrode A in parallel with the barrier ribs may be placed below the barrier ribs 29.

FIG. 3(b) is an explanatory drawing that shows a modified example of the second example. In this modified example, the branch electrodes 12 are made of the same metal material as that of the bus electrode 13. The other structures are the same as those of the second example.

### Third Example

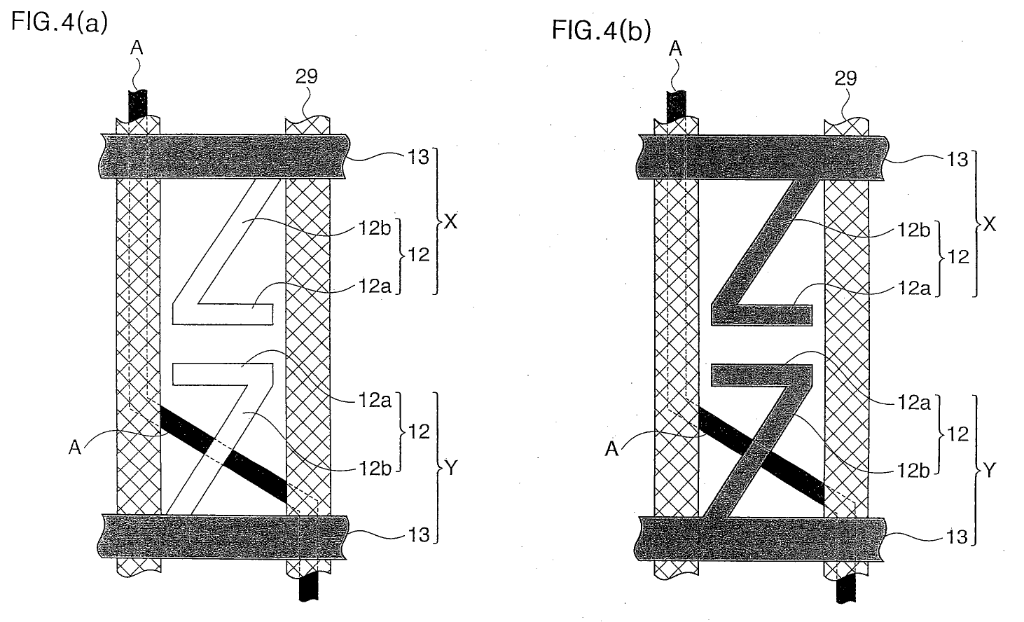

FIG. 4(a) is an explanatory drawing that shows a third example. In this example, the branch electrodes 12 have the same shape as that of the first example, and the address electrode A has the same shape as that of the second example. The electrodes having these shapes may also be used, and by using the electrodes having these shapes, even if there is a positional deviation occurring in the electrodes, the area at which the neck portion 12b and the address electrode A are superposed on each other is always allowed to have a predetermined area.

FIG. 4(b) is an explanatory drawing that shows a modified example of the third example. In this modified example, the branch electrodes 12 are made of the same metal material as that of the bus electrode 13. The other structures are the same as those of the third example.

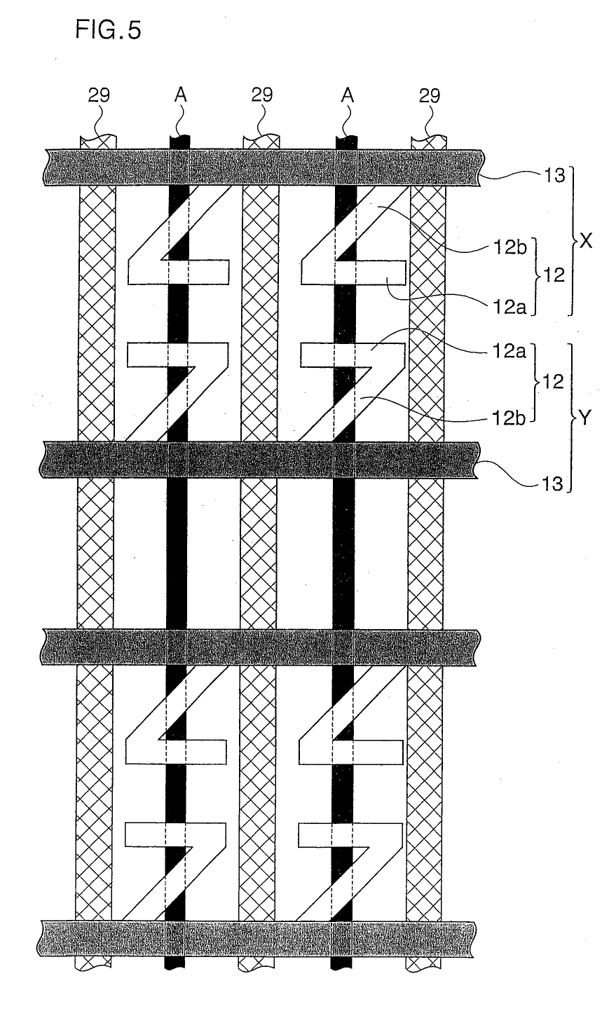

FIG. 5 is an explanatory drawing that shows an example of a state in which a positional deviation occurs in the electrodes of the first example. Those electrodes shown on the left side of the drawing are electrodes placed at normal positions, and those electrodes shown on the right side of the drawing are electrodes in which a positional deviation occurs.

As shown in FIG. 5, since, in the case of the electrode shape of the first example, the neck portion 12b is placed so as to diagonally cross each cell, with the neck portion 12b and the address electrode A being disposed so as to diagonally intersect with each other, the area at which the neck portion 12b and the address electrode A are superposed on each other is always allowed to have a predetermined area. Therefore, even if the intersecting portion between the neck portion 12b and the address electrode A deviates in either of the horizontal direction and the vertical direction, the intersecting area between the neck portion 12b and the address electrode A is kept unchanged.

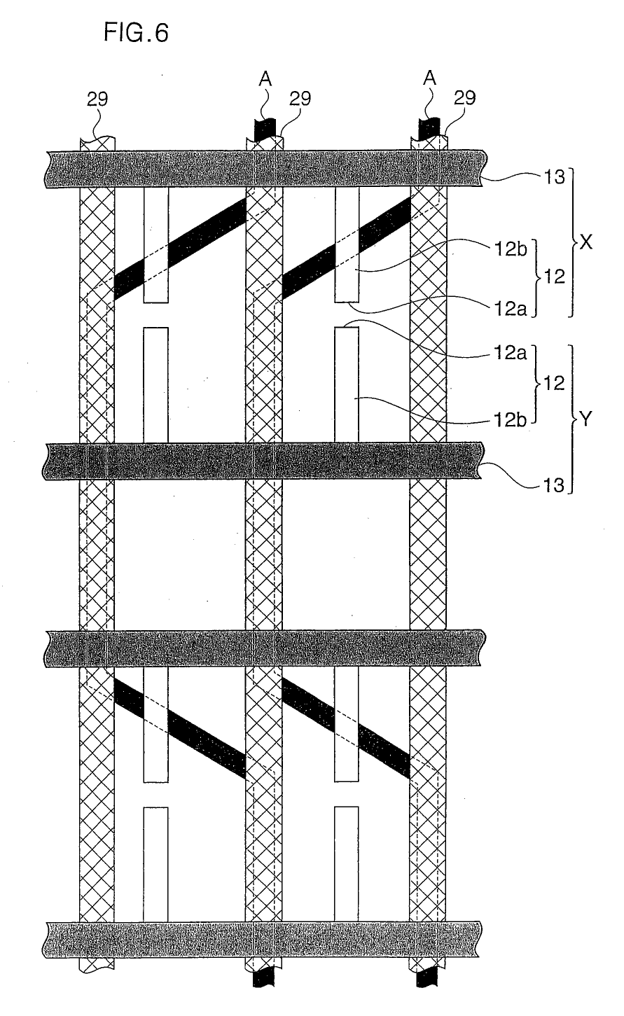

FIG. 6 is an explanatory drawing that shows an example of a state in which a positional deviation occurs in the electrodes of the second example. Those electrodes shown on the left side of the drawing are electrodes in which a positional deviation occurs, and those electrodes shown on the right side of the drawing are electrodes placed at normal positions. In this example, the head portion 12a of each branch electrode 12 has the same width as that of the neck portion 12b; however, the same effects for positional deviations of the electrodes as those of embodiment 2 can be obtained. In this example, each branch electrode of the display electrode has a strip shape.

As shown in FIG. 6, since, in the case of the electrode shape of the second example, the address electrode A is placed so as to diagonally cross each cell, with the neck portion 12b and the address electrode A being disposed so as to diagonally intersect with each other, the area at which the neck portion 12b and the address electrode A are superposed on each other is always allowed to have a predetermined area. Therefore, even if the intersecting portion between the neck portion 12b and the address electrode A deviates in either of the horizontal direction and the vertical direction, the intersecting area between the neck portion 12b and the address electrode A is kept unchanged.

As described above, in accordance with the first to third examples and modified examples of these, an electrode layout is made so that electrodes to generate an addressing counter discharge are allowed to intersect with each other; therefore, even when a positional deviation, such as an overlapping deviation, occurs between the electrodes that mutually generate an addressing counter discharge, the opposing area between the electrodes is kept unchanged. Consequently, the area at which the electrodes to generate an addressing counter discharge are overlapped with each other is evenly kept within the display surface so that no irregularities occur in the discharge starting voltage for the counter discharge, and it becomes possible to easily maintain an operating margin.

What is claimed is:

1. A plasma display panel comprising:
a pair of opposing substrates forming a discharge space therebetween;
a plurality of display electrodes placed on an inner face of one of the substrates to form display lines on a screen; and
a plurality of address electrodes placed on an inner face of the other substrate to intersect with the display electrodes and define a cell at an intersecting portion of each display electrode and each address electrode,
wherein each of the display electrodes has a band-shaped bus electrode extending over the total length of the screen in a row direction, and a plurality of branch electrodes each protruding from the bus electrode to another adjacent display electrode,
each of the branch electrodes has a head portion disposed in parallel with the bus electrode to form a discharge gap and a neck portion connecting the bus electrode and the head portion to each other, and
at least one of the neck portion and the address electrode is disposed so as to diagonally cross each cell so that an overlapped area between the neck portion and the address electrode is always formed as a certain area, whereby the neck portion and the address electrode are disposed so as to diagonally intersect with each other in a plane view of the panel.

2. The plasma display panel according to claim 1, wherein the address electrode linearly extends orthogonal to the bus electrode, and the neck portion diagonally intersects with the address electrode.

3. The plasma display panel according to claim 1, wherein the neck portion is disposed to be orthogonal to the bus electrode, and the address electrode diagonally intersects with the neck portion.

4. The plasma display panel according to claim 1, wherein the neck portion is disposed diagonally relative to each cell, and the address electrode diagonally intersects with the neck portion.

5. The plasma display panel according to claim 1, wherein the bus electrode and the branch electrodes are made of an integral metal electrode.

6. The plasma display panel according to claim 1, wherein the bus electrode is formed as an electrode made of metal, and the branch electrode is made of a transparent electrode.
